(19) United States
(12) Patent Application Publication
(10) Pub. No.: US 2003/0059044 A1
(43) Pub. Date: Mar. 27, 2003

(54) Encryption apparatus

(75) Inventors: Hideo Shimizu, Kawasaki-shi (JP); Masahiko Motoyama, Yokohama-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/242,726

(22) Filed: Sep. 13, 2002

(30) Foreign Application Priority Data
Sep. 21, 2001 (JP) 2001-290121

(51) Int. Cl. H04K 1/04

(52) U.S. Cl. 380/37

(57) ABSTRACT

An encryption apparatus comprises a first to n-th registers, a non-linear transformer that non-linearly transforms blocks of initial data retained in the first register, on the basis of key information and then outputs the non-linearly transformed blocks, a linear transformer that linearly transforms the non-linearly transformed data output from the non-linear transformer and then outputs the linearly transformed data, and a first to n-th two-input selectors which connect output ends of the second to n-th registers and non-linear transformer to the first to n−1-th registers, respectively, if the selectors are brought into a first state by a control signal and which connects a first to n-th output ends of the linear transformer to input ends of the first to n-th registers, respectively, if the selectors are brought into a second state by a control signal.

### CROSS-REFERENCE TO RELATED APPLICATIONS

This application is based upon and claims the benefit of priority from the prior Japanese Patent Application No. 2001-290121, filed Sep. 21, 2001, the entire contents of which are incorporated herein by reference.

### BACKGROUND OF THE INVENTION

1. Field of the Invention

The present invention relates to an encryption apparatus, and in particular, to an encryption apparatus having an SPN (Substitution-Permutation Network) structure.

2. Description of the Related Art

To process block cipher, conventional encryption apparatuses use an algorithm having a Feistel type structure specified in the DES (Data Encryption Standard). Instead of this algorithm, an algorithm having an SPN structure such as the one disclosed in Rijndael or Hierocrypt has more and more frequently been used for block cipher. Rijndael is described in detail in, for example, a document disclosed so as to be available at http: www.nist.gov/aes/. Further, Hierocrypt is described in detail in, for example, “Evaluation of Strength/Performance of Block Hierocrypt-3 and Hierocrypt-L1”, The Institute of Electronics, Information and Communication Engineers, Shingakugiho, ISEC2000-71(2000-09).

A block encryption process has more frequently been mounted in small-sized information equipment such as cellular phones and PDAs. Owing to limitations on batteries, many pieces of small-sized equipment operate at low clock frequencies. Thus, it is difficult to execute encryption processes at high speed using software. Consequently, there has been a growing demand for small-sized hardware for encryption which requires reduced power consumption.

In the prior art, the block encryption is composed of repetition of a round function. Accordingly, to reduce the size of the hardware, only one circuit element that processes a round function is often mounted to repeat processing this function.

With the SPN type structure, not only a round function of the same structure has a repeated structure but also a similar structure is repeated within the round function.

A common approach to reducing the size of the hardware has been known; if a plurality of registers are caused to execute the same process, only one register circuit part for processing is mounted and used in a time-division manner by using a multi-input selector to switch an input/output of the register circuit part.

The selector-based size reduction approach is also applicable to the above described repeated structure within a round function.

However, the scale of a multi-input selector circuit disadvantageously increases consistently with the number of input lines. That is, with the selector-based size reduction approach, if circuit elements are shared by a large number of input signals, the size of the circuit can be more sharply reduced as more input signals share a predetermined number of circuit elements. However, the size of the selector increases linearly with the number of input signals. This reduces the circuit element reduction effect on the circuit as a whole.

As described above, with the multi-input selector-based method, a conventional typical size reduction approach, even if the number of processes executed in the same processing circuit is increased, the scale of circuit of the selector itself must be increased, thereby disadvantageously saturating the circuit scale reduction effect.

### BRIEF SUMMARY OF THE INVENTION

It is an object of the present invention to provide an SPN type encryption apparatus that uses no multi-input selectors.

According to an aspect of the invention, there is provided an encryption apparatus for encrypting data using round function processes, comprising:

first to n-th register modules electrically arranged in series, each register module having a selector in order to select data and a register in order to store the selected data temporally and in order to output the stored data;

a first transform unit, connected to the register in the first register module, configured to transform data outputted from the register in the first register module according to an input key and output the transformed data to the selector in the n-th register module; and,

a second transform unit, connected to the registers, configured to input data from the registers respectively, merge the inputted data, transform the merged data by a predetermined linear transform method, divide the transformed data into n number, and output the divided data to the selectors of the register module, respectively.

According to an another aspect of the invention, there is provided an decryption apparatus for decrypting data using round function processes, comprising:

first to n-th register modules electrically arranged in series, each register module having a selector in order to select data and a register in order to store the selected data temporally and in order to output the stored data;

a first transform unit, connected to the register in the first register module, configured to transform data outputted from the register in the first register module according to an input key and output the transformed data to the selector in the n-th register module; and,

a second transform unit, connected to the registers, configured to input data from the registers respectively, merge inputted data, transform the merged data by a predetermined linear transform method, divide the transformed data into n number, and output the divided data to the selectors of the register module, respectively.

According to a yet another aspect of the invention, there is provided an encryption apparatus for encrypting data using round function processes, comprising:

loop circuits, each including;

first to n-th register modules electrically arranged in series, each register module having a selector in order to select data and a register in order to store the selected data temporally and in order to output the stored data; and

a first transform unit, connected to the register in the first register module, configured to transform data outputted from the register in the first register module according to an input key and output the transformed data to the selector in the n-th register module, and the series arrangement of the register modules and the first transformed forming one of the loop circuit; and,

a second transform unit, connected to the registers of the loop circuits, configured to input data from registers respectively, merge inputted data, transform the merged data by a predetermined linear transform method, divide the transformed data into n number, and output the divided data to the selectors of the register module, respectively.

According to a further aspect of the invention, there is provided a decryption apparatus for decrypting data using round function processes, comprising:

circuit loops, each including;

first to n-th register modules electrically arranged in series, each register module having a selector in order to select data and a register in order to store the selected data temporally and in order to output the stored data; and

a first transform unit, connected to the register in the first register module, configured to transform data outputted from the register in the first register module according to an input key and output the transformed data to the selector in the n-th register module; and,

a second transform unit, connected to the registers of the loop circuits, configured to input data from registers respectively, merge inputted data, transform the merged data by a predetermined linear transform method, divide the transformed data into n number, and output the divided data to the selectors of the register module, respectively.

### BRIEF DESCRIPTION OF THE SEVERAL VIEWS OF THE DRAWING

FIG. 1 is a block diagram useful in describing a basic process for SPN type encryption;

FIG. 2 is a block diagram showing an example of the configuration of an SPN type encryption apparatus according to an embodiment of the present invention;

FIG. 3 is a table useful in describing control provided by a two-input selector shown in FIG. 2;

FIG. 4 is a diagram useful in describing a round function for SPN type encryption shown in FIG. 2;

FIGS. 5A to 5E are block diagrams useful in describing operations of the SPN type encryption apparatus shown in FIG. 2;

FIG. 6 is a flow chart showing an example of a process procedure executed by the SPN type encryption apparatus shown in FIG. 2;

FIG. 7 is a diagram useful in describing the basic structure of SPN type decryption;

FIG. 8 is a block diagram showing an example of the configuration of an SPN type decryption apparatus according to an embodiment of the present invention;

FIG. 9 is a table useful in describing control provided by a two-input selector shown in FIG. 8;

FIG. 10 is a diagram useful in describing a round function for SPN type decryption shown in FIG. 8;

FIGS. 11A to 11E are block diagrams useful in describing operations of the SPN type decryption apparatus shown in FIG. 8;

FIG. 12 is a flow chart showing an example of a process procedure executed by the SPN type decryption apparatus shown in FIG. 8;

FIG. 13 is a block diagram showing an example of the configuration of an SPN type encryption apparatus according to another embodiment of the present invention;

FIGS. 14A to 14C are block diagrams useful in describing operations of the SPN type encryption apparatus shown in FIG. 13;

FIG. 15 is a block diagram showing an example of the configuration of an SPN type decryption apparatus according to another embodiment of the present invention; and

FIGS. 16A to 16C are block diagrams useful in describing operations of the SPN type decryption apparatus shown in FIG. 15.

### DETAILED DESCRIPTION OF THE INVENTION

Encryption apparatuses according to embodiments of the present invention will be described below with reference to the drawings.

With SPN type encryption, input data are sequentially and repeatedly processed by an internal function called a “round function”. That is, the input data are non-linearly transformed a number of times. For simplification, description will be given below of a specific example in which non-linear transformation is repeated four times. Obviously, the encryption apparatus of the present invention is not limited to the four non-linear transforming operations, but is of course applicable to the case where non-linear transformation is repeated twice or three times, or five or more times.

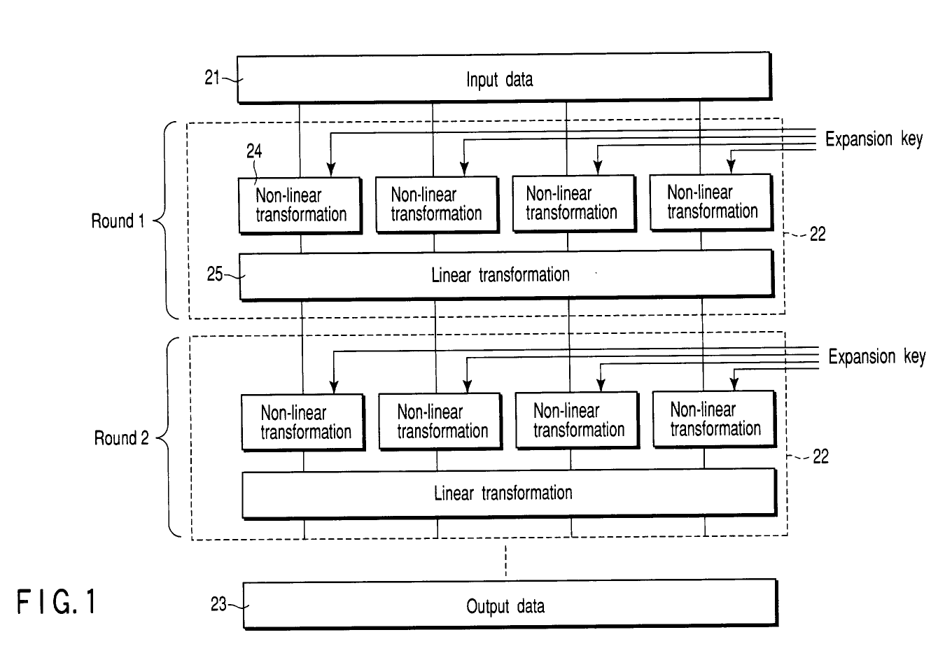

First, the basic process for SPN type encryption will be described with reference to FIG. 1. This figure is a block diagram showing the basic process for SPN type encryption in terms of functions.

As shown in FIG. 1, with an SPN type encryption process, input data 21 are sequentially processed a number of times by a round function 11 having the same structure, and are thus transformed into encrypted output data 23. In FIG. 1, in a round 1, the input data 22 are processed by the round function 22. In a round 2, the output data from the round 1 are processed by the round function 22. In the next round, the output data from the round 2 are processed by the round function 22. This process is repeated.

In the round 1, where the input data 21 are processed by the round function 22, input initial data of m bits input to the round function 22 are divided into n data blocks each having m/n bits. The data blocks are each subjected to non-linear transformation 24 according to a given expansion key, i.e., an input key, supplied from a key scheduler (not shown). Subsequently, the n non-linearly transformed data blocks are output by the n non-linear transformation functions 24 as m-bit output data. The m-bit output data are then subjected to linear transformation 25. Likewise, in the round 2, the linearly transformed data from the round 1 are separated into n data blocks each having m/n bits. These n data blocks are then subjected to the non-linear transformation 24 by the corresponding non-linear functions, m-bit output data from the n non-linear transformation functions 24 are subjected to the linear transformation 25 again. Processes similar to those executed in the round 1 and 2 are repeated over a predetermined number of rounds. Finally, the encrypted output data 23 are output.

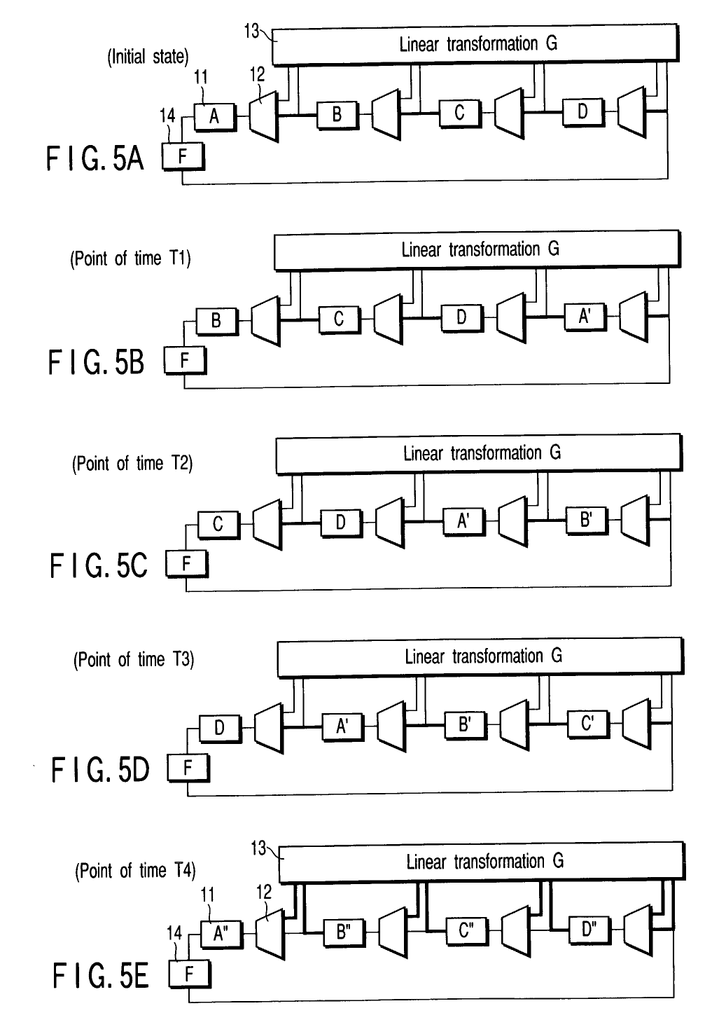

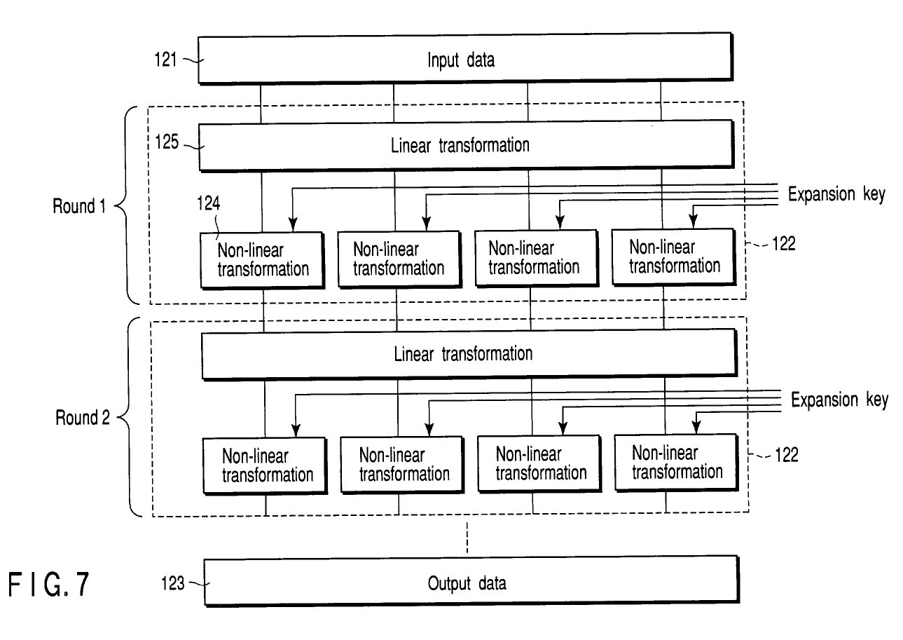

The non-linear transformation 24 and the linear transformation 25 are described in detail in the U.S. patent application Ser. No. 09/799,028 (inventor: Kenji Ohkuma et al.), filed on Mar. 6, 2001. The entire contents of the U.S. patent application Ser. No. 09/799,028 are incorporated herein by reference, and description thereof is omitted. In particular, the non-linear transformation 24 is described with reference to FIG. 5 of this specification. The linear transformation 25 is described with reference to FIG. 7 of this specification. Further, the linear transformation 25 is described in 5.1.1 SubBytes ( ) Transformation and 5.1.2 ShiftRows ( ) Transformation of 5.1 Cipher of AES (ADVANCED ENCRYPTION STANDARD), Federal Information, Processing Standards Publication 197, Nov. 26, 2001. Accordingly, also refer to these documents for the non-linear transformation 24 and the linear transformation 25.

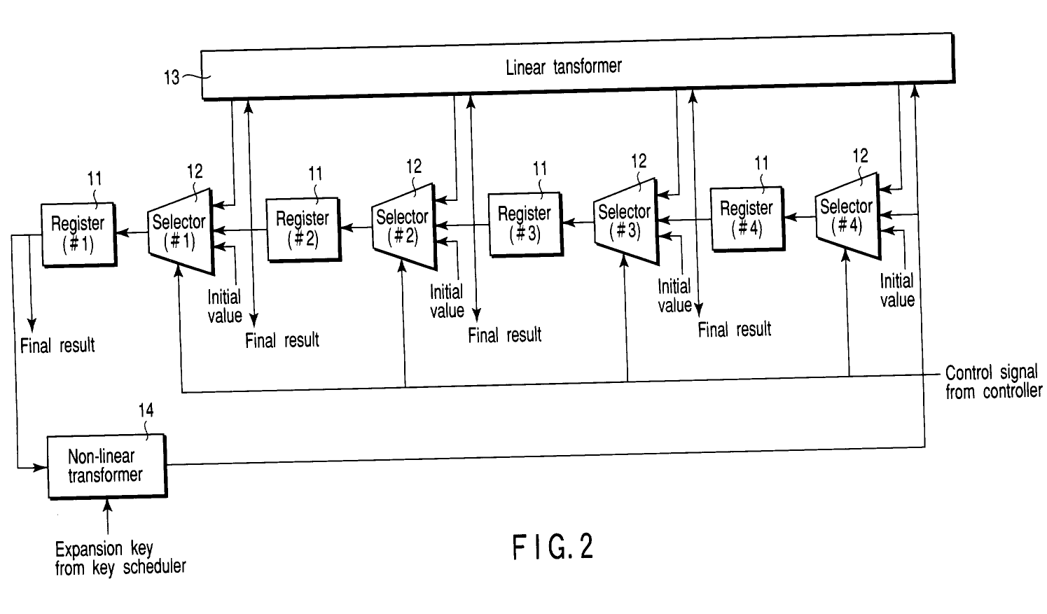

With reference to FIGS. 2 to 12, description will be given of an SPN type encryption apparatus according to an embodiment of the present invention which is based on the data encryption described above.

FIG. 2 is a schematic block diagram of the SPN type encryption apparatus according to the embodiment of the present invention.

In the encryption apparatus shown in FIG. 2, m-bit input data are separated into n initial data blocks as described with reference to FIG. 1. The n initial data blocks are input to corresponding registers 11 as initial values. In this encryption apparatus, the n data blocks are encrypted, and the n registers 11 then output the respective final data blocks as final results. The set of n final data blocks is output as m-bit encrypted output data. The encryption apparatus has the n registers 11 arranged in series so as to correspond to the n data blocks, respectively. At the beginning of encryption, in response to a control signal, each of the registers 11 receives and retains the corresponding initial data block. On the other hand, at the end of encryption, in response to a control signal, the register 11 retains and outputs the final data block-the apparatus shown in FIG. 2 is shown having four registers 11 (n=4). The encryption apparatus comprises n two-input selectors 12 each connected to an input of the corresponding register 11. Each of the selectors 12 has its input switched in response to a control signal. Furthermore, the encryption apparatus comprises a linear transformer 13 which has the linear transformation function 25, shown in FIG. 1, and to which n data blocks are provided by the registers 11. The linear transformer 13 linearly transforms m-bit data corresponding to a set of n data blocks, separates the m-bit data into n data blocks, and outputs these data blocks to the selectors 12. Further, the encryption apparatus comprises a nonlinear transformer 14 which has the non-linear transformation function 24, shown in FIG. 1, and which is provided with an expansion key, supplied from a key scheduler (not shown), to non-linearly transform the data blocks. The control signals are provided to the registers 11 by a control part (not shown) that controls the entire apparatus. The expansion key is provided to the non-linear transformer 14 by the key scheduler of a key processing part (not shown) A loop is formed by the series circuit consisting of the n registers 11, n two-input selectors 12, and non-linear transformer 14.

In the following description, the registers 11 and selectors 12 are numbered (#1 to #n; in FIG. 2, n=4). Here, of the registers providing data blocks to the non-linear transformer 14, the leading register 11 is called the “first register 11 (#1)”, the register 11 located behind the first register 11 is called the “second register 11 (#2), . . . , the trailing register is called the “n-th register 11 (#n)”. In FIG. 2, the trailing register corresponds to the fourth register (#4). Similarly, the selector located behind the first register 11 (#1) is called the “first selector 12 (#1)”, the selector located behind the register 2 is called the “second selector 12 (#2)”, . . . , the selector located behind the trailing register is called the “n-th selector 12 (#n; in FIG. 4, the fourth selector 4)”.

Here, the i-th selector 12 (i=1 to n) receives either a first input in_S1_i or a second input in_S2_i, and the i-th selector 11 (i=1 to n) provides an output out_S_i. Further, the i-th register 11 (i=1 to n) receives an input in_R_i and provides an output out_R_i. Accordingly, the i-th (i=1 to n) input to the linear transformer 13 is denoted as in_N_i, and the i-th (i=1 to n) output therefrom is denoted as out_L_i. Further, the first input to the non-linear transformer 14 is denoted as in_N_1, the second input thereto is denoted as in_L_2, and an output therefrom is denoted as out_N.

Thus, in FIG. 2, the first inputs in_S1_1 to in_Sn_1 of the selectors 1 to n are connected to the outputs out_L_1 to out_L_n of the linear transformer, respectively. The second inputs in_S1_2 to in_Sn-1_2 of the selectors 1 to n−1 are connected to the outputs out_R2 to out_Rn of the registers 2 to n, respectively. The second input in_Sn_2 of the selector n is connected to the output out_N of the non-linear transformer. The inputs in_R_1 to in_R_n of the registers 1 to n are connected to the outputs out_S_1 to out_S_n of the selectors 1 to n, respectively. The first to n−1-th inputs in_L_1 to in_L_n−1 of the linear transformer are connected to the outputs out_R_2 to out_R_n of the registers 2 to n, respectively. The n-th input in_L_n of the linear transformer is connected to the output out_N of the non-linear transformer. The first input in_N_1 of the non-linear transformer is connected to the output out_R1 of the register 1. The second input in_N_2 of the non-linear transformer is provided with the expansion key.

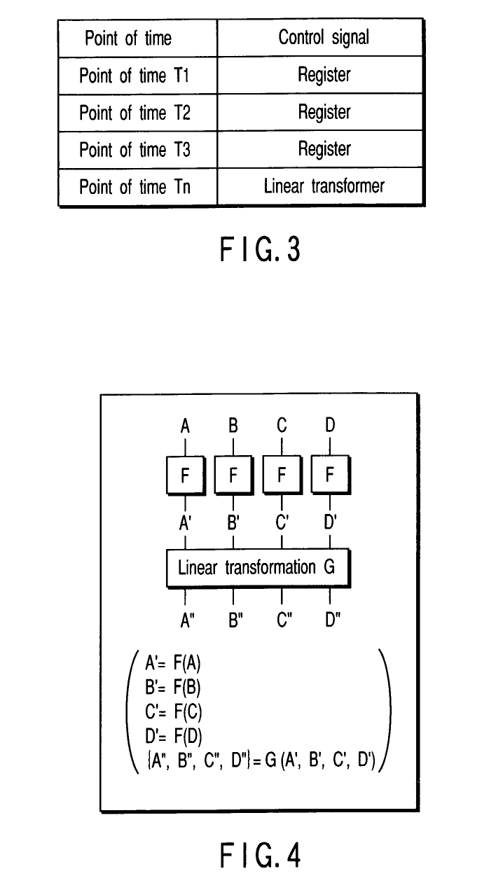

Each two-input selector 12 has its input terminal switched in response to a control signal from the control part (not shown). FIG. 3 shows the relationship between a certain point of time Ti (T1 to Tn; n=4) and an input (the register 11 or the linear transformer 13) selected by the selector 12 in response to a control signal provided to the selector 12 at the point of time Ti (T1 to Tn).

Now, an operation of the encryption apparatus shown in FIG. 2 will be described with reference to FIG. 4.

FIG. 4 shows how the encryption apparatus shown in FIG. 2 processes SPN type encryption using a round function. As shown in this figure, data to be processed by the round function are divided into n data blocks A, B, C, and D, which are then input to the encryption apparatus. In this embodiment, the data are separated into the four data blocks. The input data block A is subjected to non-linear transformation F and thus transformed into a data block A′ (A′=F(A)). Similarly, the input data blocks B, C, and D are subjected to the non-linear transformation F and thus transformed into data blocks B′, C′, and D′ (B′=F(B), C′=F(C), and D′=F(D)). In the circuit shown in FIG. 2, the non-linear transformer 14 subjects the data blocks A, B, C, and D to the non-linear transformation F to convert them into the data blocks A′, B′, C′, and D′. Further, the data blocks A′, B′, C′, and D′ are subjected to linear transformation and thus transformed into data blocks A″, B″, C″, and D″ ({A″, B″, C″, D″}=G (A′, B′, C′, D′)). In the circuit shown in FIG. 2, the linear transformer 13 subjects the data blocks A′, B′, C′, and D′ to the linear transformation G to convert them into the data blocks A″, B″, C″, and D″.

FIGS. 5A to 5E use the same symbols as those shown in FIG. 4 to show how the encryption apparatus executes transformation equivalent to that shown in FIG. 4. FIG. 5A shows an initial state in which the segment data A, B, C, and D are input to the registers 11. FIGS. 5B, 5C, and 5D show processes executed at points of time T1, T2, and T3, respectively, if the selectors 12 select the inputs from the corresponding registers 11 as shown in FIG. 3. FIG. 5E shows a process executed at a point of time Tn if the selectors 12 select the inputs from the linear transformer 13 as shown in FIG. 3.

In the initial state, the data blocks A, B, C, and D are input to the registers 11 (#1 to #4) and retained therein as shown in FIG. 5A.

At the point of time T1, a non-linear transformation mode is set. As shown in FIG. 5B, the data block A, set in the first register 11 (#1), is output to the non-linear transformer 14 in response to a control signal. In the non-linear transformer 14, the data block A is subjected to the non-linear transformation F and thus transformed into the data block A′. The data block A′ is transferred to the fourth register 11 (#4) via the selector 12 selecting the non-linear transformer 14, and is retained in the fourth register 11 (#4). Further, at the point of time Ti, the data blocks B, C, and D, placed in the other registers 11 (#2 to #4), are shifted to the respective adjacent registers 11 (#1 to #3) via the selectors 12 selecting these registers 11 (#1 to #3), respectively. As a result, after the point of time T1, the registers 11 (#1 to #4) retain the data blocks B, C, D, and A′, respectively, as its contents.

Also at the point of time T2, the non-linear transformation mode is set. As shown in FIG. 5C, the data block B, set in the first register 11 (#1), is similarly output to the non-linear transformer 14. In the non-linear transformer 14, the data block B is subjected to the non-linear transformation F and thus transformed into the data block B′. The data block B′ is transferred to the fourth register 11 (#4) via the selector 12 selecting the non-linear transformer 14, and is retained in the fourth register 11 (#4). Further, at the point of time T2, the data blocks C, D, and A′, placed in the other registers 11 (#2 to #4), are shifted to the respective adjacent registers 11 (#1 to #3) via the selectors 12 selecting these registers 11 (#2 to #4), respectively. As a result, after the point of time T2, the registers 11 (#1 to #4) retain the data blocks C, D, A′, and B′, respectively, as its contents.

Also at the point of time T3, the non-linear transformation mode is set. As shown in FIG. 5D, the data block C, set in the first register 11 (#1), is similarly output to the non-linear transformer 14. In the non-linear transformer 14, the data block C is subjected to the non-linear transformation F and thus transformed into the data block C′. The data block C′ is transferred to the fourth register 11 (#4) via the selector 12 selecting the non-linear transformer 14, and is retained in the fourth register 11 (#4). Further, at the point of time T2, the data blocks D, A′, and B′, placed in the other registers 11 (#2 to #4), are shifted to the respective adjacent registers 11 (#1 to #3) via the selectors 12 selecting these registers 11 (#2 to #4), respectively. As a result, after the point of time T2, the registers 11 (#1 to #4) retain the data blocks D, A′, B′, and C′, respectively, as its contents.

At the point of time Tn, the non-linear transformation mode is switched to a linear transformation mode, which is then set. In this linear transformation modes, as shown in FIG. 5E, the data block D, set in the first register 11 (#1), is output to the non-linear transformer 14. In the non-linear transformer 14, the data block D is subjected to the non-linear transformation F and transformed into the data block D′. Further, at the point of time Tn, the linear transformer 13 receives the data block A′, retained in the second register 11 (#2), the data block B′, retained in the third register 11 (#3), the data block C′, retained in the fourth register 11 (#4), and the data block D′, output by the linear transformer 14. In the linear transformer 13, the data blocks A′, B′, C′, and D′ are subjected to the linear transformation G and linearly transformed into the data blocks A″, B″, C″, and D″. The data blocks A″, B″, C″, and D″ are transferred to the registers 11 (#1 to #4) via the selectors 1 to 4 selecting the linear transformer 13 at the point of time Tn, and are retained in these registers.

The process shown in FIGS. 5A to 5E corresponds to one stage of a round function. If a round function composed of a plurality of stages is repeated, the final result of the preceding round function may be directly input as an initial value for the following function. Then, a procedure similar to the one shown in FIGS. 5A to 5E may be executed.

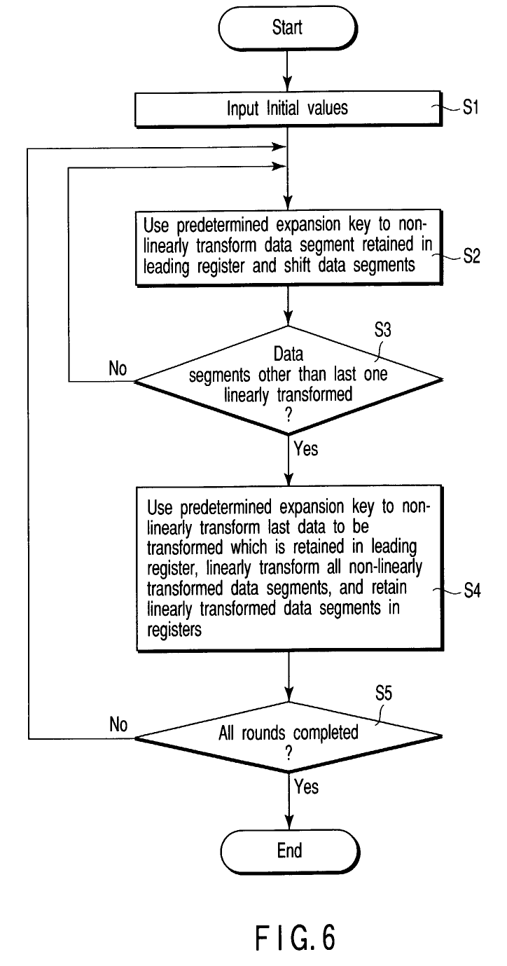

FIG. 6 shows an example of a process procedure executed if the encryption apparatus shown in FIG. 2 repeats a process using a round function composed of a plurality of stages. When this process is started, the registers 11 receive and retain corresponding initial values (step S1). The initial values each correspond to a data block having m/n bits if m-bit data are separated into n blocks.

In response to a control signal from the control part (not shown), the non-linear transformation mode is set, and the selectors 12 select the corresponding registers 11. The segment data retained in the leading register 11 are input to the non-linear transformer 14. Then, the non-linear transformer 14 non-linearly transforms the segment data using the expansion key provided by a key processing part (not shown). As described previously, the other data blocks are shifted to the respective adjacent registers and retained therein (step S2).

The processing in step S2 is repeated until the data blocks other than the last to be non-linearly transformed are non-linearly transformed (step S3).

Finally, when the last data block to be nonlinearly transformed is non-linearly transformed, the linear transformation mode is set in response to a control signal from the control part (not shown). Then, the selectors 12 select the linear transformer 13. Further, the last data block to be transformed, retained in the leading register 11 (#1), is input to the non-linear transformer 14. Then, the non-linear transformer 14 non-linearly transforms the data block using the expansion key provided by the key processing part (not shown). After all data blocks have been non-linearly transformed, they are input to the linear transformer 13 for linear transformation. All data blocks from the linear transformer 13 are output to the corresponding registers 11 via the respective selectors 12 as linearly transformed data blocks and are retained in these registers 11 (step S4). Consequently, one stage of the round function is applied to data to be processed, with the result retained in the register. Thus, one round is completed.

Now, description will be given of a decryption apparatus corresponding to the encryption apparatus shown in FIG. 2.

With reference to FIG. 7, description will be given of the basic structure of SPN type decryption corresponding to the SPN type encryption shown in FIG. 1.

FIG. 7 shows the basic structure of the SPN type decryption corresponding to the SPN type encryption shown in FIG. 1. As shown in FIG. 7, also in the SPN type decryption, input data 121 are transformed into output data 123 by applying a round function 122 having the same structure to the input data 121 a number of times. Here, attention is paid to the interior of the round function 122. m-bit input data to be processed by the round function are first subjected to a linear transformation function 125. Then, data output from the linear transformation function 125 are divided into n data blocks each having m/n bits. These data blocks are transformed by non-linear transformation functions 124. These series of processes complete one round.

A similar round process is repeated a predetermined number of times. The final outputs from the non-linear transformation functions 124 are output by the decryption apparatus as output data 123.

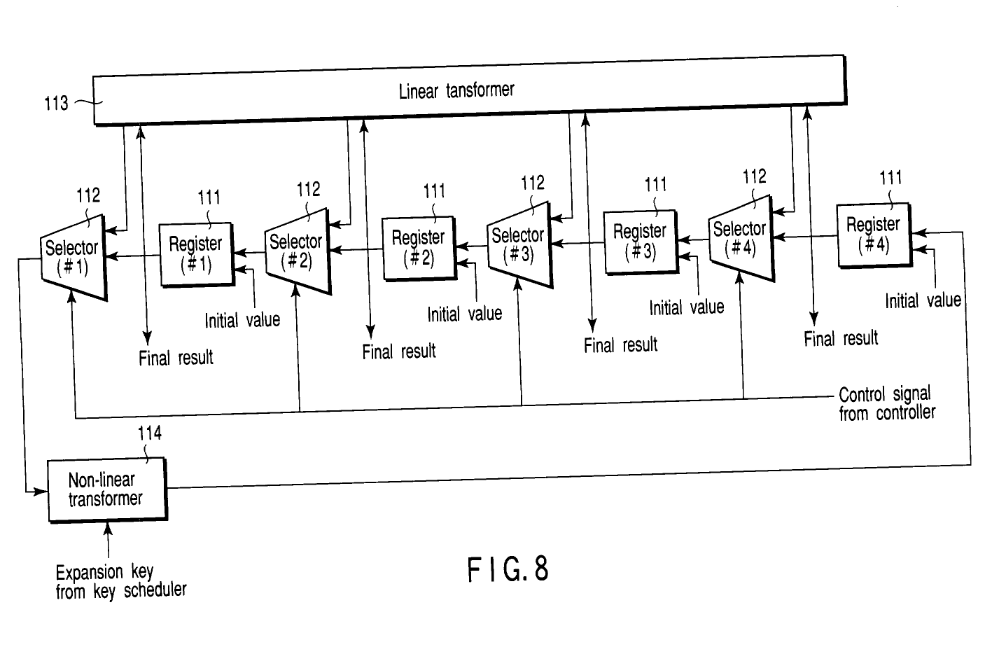

FIG. 8 is a block diagram showing an SPN type decryption apparatus according to an embodiment of the present invention. The SPN decryption apparatus according to this embodiment of the present invention will be described with reference to FIG. 8. In order to solve the problems inherent to the multi-input selector, described in the background art, the SPN type decryption apparatus shown in FIG. 8, like the encryption apparatus shown in FIG. 2, uses a two-input selector instead of a multi-input selector to implement a circuit configuration having the decryption function shown in FIG. 7.

As shown in FIG. 8, in this decryption apparatus, m-bit input data are separated into n initial data blocks as described with reference to FIG. 7. The n initial data blocks are input to corresponding registers 111 as initial values. In this decryption apparatus, the n data blocks are decrypted, and the n registers 111 then output the respective final data blocks as final results. The set of n final data blocks is output as m-bit decrypted output data. The decryption apparatus has the n registers 111 arranged in series so as to correspond to the n data blocks, respectively. At the beginning of decryption, in response to a control signal, each of the registers 111 receives and retains the corresponding initial data block. On the other hand, at the end of decryption, in response to a control signal, the register 111 retains and outputs the final data block-the apparatus shown in FIG. 8 is shown having four registers 11 (n=4). The decryption apparatus comprises n two-input selectors 12 each connected to an input of the corresponding register 11. Each of the selectors 12 has its input switched in response to a control signal. Furthermore, the decryption apparatus comprises a linear transformer 113 which has the linear transformation function 125, shown in FIG. 7, and to which n data blocks are provided by the registers 111. The linear transformer 113 linearly transforms m-bit data corresponding to a set of n data blocks, separates the m-bit data into n data blocks, and outputs these data blocks to the selectors 12. Further, the decryption apparatus comprises a non-linear transformer 114 which has the non-linear transformation function 124, shown in FIG. 1, and which is provided with an expansion key to non-linearly transform the data blocks. The control signals are provided to the registers 111 by a control part (not shown) that controls the entire apparatus. The expansion key is provided to the non-linear transformer 114 by a key processing part (not shown). A loop is formed by the series circuit consisting of the n registers 111, n two-input selectors 112, and non-linear transformer 114.

The linear transformation carried out by the linear transformer 113 corresponds to the inverse of the linear transformation G, carried out by the linear transformer 13 of the SPN type decryption apparatus in FIG. 2, i.e. an inverse function G⁻¹. The non-linear transformation carried out by the non-linear transformer 113 corresponds to the inverse of the linear transformation F, carried out by the non-linear transformer 14 of the SPN type decryption apparatus in FIG. 2, i.e. an inverse function F⁻¹.

In the following description, the registers 111 and selectors 112 are numbered, as described with reference to FIG. 2. Here, the trailing register retaining a data block form the non-linear transformer 114 is called the “n-th register 111 (#n)”. In FIG. 8, the trailing register corresponds to the fourth register 111 (#4). The register located in front of the trailing register is called the “n−1 register 11 (#n−1), . . . , the leading register is called the “first register 111 (#1)”. Further, the selector located in front of the first register 111 (#1) is called the “first selector 112 (#1)”, the selector located in front of the register 2 is called the “selector 2”, . . . , the selector located in front of the n-th register 111 (#n) is called the “n-th selector 112 (#n) (in this specific example, the selector 4)”. In FIG. 8, the n-th selector n (#n) corresponds to the fourth selector 112 (#4).

Here, the i-th selector 112 (i=1 to n) receives either a first input in_S1_i or a second input in_S2_i, and the i-th selector 11 (i=1 to n) provides an output out_S_i. Further, the i-th register 111 (i=1 to n) receives an input in_R_i and provides an output out_R_i. Accordingly, the i-th (i=1 to n) input to the linear transformer 113 is denoted as in_N_i, and the i-th (i=1 to n) output therefrom is denoted as out_L_i. Further, the first input to the non-linear transformer 114 is denoted as in_N_1, the second input thereto is denoted as in_L_2, and an output therefrom is denoted as out_N.

Thus, in FIG. 8, the first inputs in_S1_1 to in_Sn_1 of the selectors 112 (#1 to #n) are connected to the outputs out_L_1 to out_L_n of the linear transformer, respectively. The second inputs in_S1_2 to in_Sn_2 of the selectors 112 (#1 to #n) are connected to the outputs out_R1 to out_Rn of the registers 111 (#1 to #n), respectively. The inputs in_R_1 to in_R_n−1 of the registers 111 (#1 to #n) are connected to the outputs out_S_2 to out_S_n of the selectors 112 (#2 to #n), respectively. The input in_R_n of the register 111 (#n) is connected to the output out_N of the non-linear transformer. The first to n-th inputs in_L_1 to in_L_n of the linear transformer 113 are connected to the outputs out_R_1 to out_R_n of the registers 1 to n, respectively. The first input in_L_1 of the non-linear transformer 114 is connected to the output out_S_1 of the selector 112 (#1). The second input in_N_2 of the non-linear transformer corresponds to the expansion key.

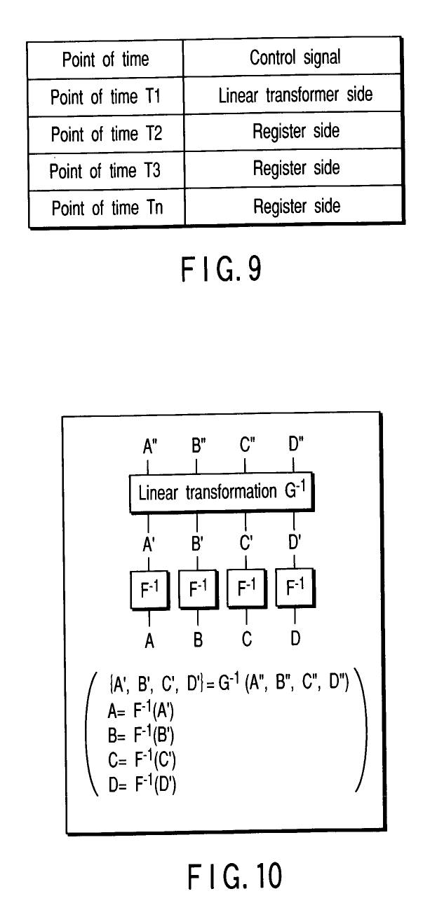

Each two-input selector 12 has its input terminal switched in response to a control signal from the control part (not shown). FIG. 9 shows the relationship between a certain point of time Ti (T1 to Tn; n=4) and an input (the register 111 or the linear transformer 113) selected by the selector 12 in response to a control signal provided to the selector 12 at the point of time Ti (T1 to Tn).

Now, an operation of the decryption apparatus shown in FIG. 8 will be described with reference to FIG. 10.

FIG. 10 shows how the decryption apparatus shown in FIG. 8 processes SPN type encryption using a round function. As shown in this figure, data to be processed by the round function are divided into n data blocks A″, B″, C″, and D″, which are then input to the decryption apparatus. In this embodiment, the data are separated into the four data blocks. In the circuit shown in FIG. 8, the data blocks A″, B″, C″, and D″ are subjected to the linear transformation G⁻¹ and thus transformed into data blocks A′, B′, C′, and D′ ({A′, B′, C′, D′})=G⁻¹ (A″, B″, C″, D″)). The input data block A′ is subjected to the non-linear transformation F⁻¹ and thus transformed into a data block A (A=F⁻¹(A′)). Similarly, the input data blocks B′, C′, and D′ are subjected to the non-linear transformation F⁻¹ and thus transformed into data blocks B, C, and D (B=F⁻¹(B′), C=F⁻¹(C′), and D=F⁻¹(D′)).

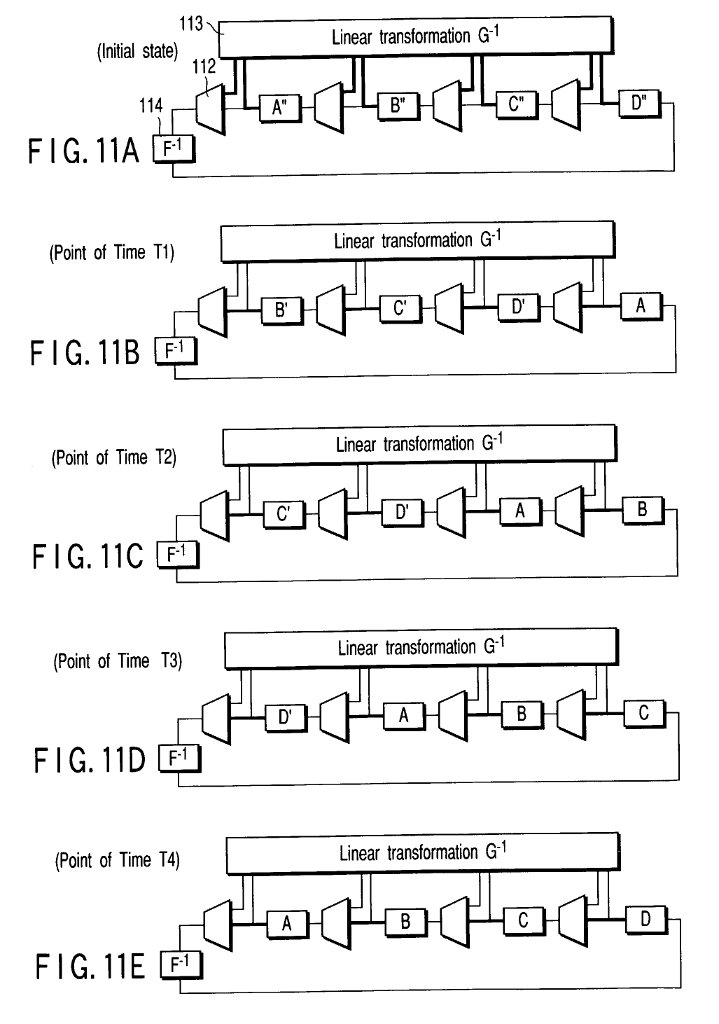

FIGS. 11A to 11E use the symbols shown in FIG. 10 to show how the decryption apparatus shown in FIG. 8 executes transformation equivalent to that shown in FIG. 10. FIG. 11A shows an initial state in which the segment data A″, B″, C″, and D″ are input to the registers 11. FIG. 5B shows a process executed at a point of time T1 if the selectors 111 select the inputs from the linear transformer 113 as shown in FIG. 10. Further, FIGS. 11C to 11E show processes executed at points of time T2, T3, and Tn, respectively, if the selectors 112 select the inputs from the corresponding registers 111 as shown in FIG. 9.

In the initial state, the data blocks A″, B″, C″, and D″ are input to the registers 111 (#1 to #4) and retained therein as shown in FIG. 11A.

At the point of time T1, a linear transformation mode is set. As shown in FIG. 11B, the linear transformer 113 receives the data block A″, retained in the register 111, the data block B″, retained in the register 2, the data block C″, retained in the register 3, and the data block D′, retained in the register 3. The linear transformer 113 subjects the data blocks A″, B″, C″, and D″ to the linear transformation G⁻¹ to transform them into the data blocks A′, B′, C′, and D′. The data blocks B′, C′ and D′ obtained are transferred to the registers 111 (#1 to #3) via the selectors 112 (#2 to #4) and are retained in these registers. The data block A′ is provided to the non-linear transformer 114 via the selector 112 (#1) and subjected to the nonlinear transformation F. The data block A obtained is retained in the register 111 (#4). As a result, the registers 111 (#1 to #4) retain the data blocks B′, C′, D′, and A.

At the point of time 2, the linear transformation mode is switched to a non-linear transformation mode, which is then set. In this non-linear transformation mode, as shown in FIG. 11C, the data B′, set in the register 111 (#1), is provided to the non-linear transformer 14 via the selector 112 (#1) and is then subjected to the non-linear transformation F. The data block B obtained is retained in the register 111 (#4). On the other hand, the data blocks C′, D′, and A in the other registers 111 (#2 to #4) are shifted to the respective adjacent registers 111 (#1 to #3) via the selectors 12 selecting these registers 111 (#2 to #4), respectively. As a result, the registers 111 (#1 to #4) retain the data blocks C′, D′, A, and B, respectively, as its contents.

At the point of time 3, the non-linear transformation mode is maintained. As shown in FIG. 1D, the data block C′, set in the register 111 (#1), is provided to the non-linear transformer 14 via the selector 112 (#1) and is then subjected to the non-linear transformation F. The data block C obtained is retained in the register 4. On the other hand, the data blocks D′, A, and B in the other registers 111 (#2 to #4) are shifted to the respective adjacent registers 111 (#1 to #3) via the selectors 12 selecting these registers 111 (#2 to #4), respectively. As a result, the registers 111 (#1 to #4) retain the data blocks D′, A, B, and C, respectively, as its contents.

At the point of time Tn, the non-linear transformation mode is maintained. As shown in FIG. 11E, the data block D′, set in the register 111 (#1), is provided to the non-linear transformer 14 and is then subjected to the non-linear transformation F. The data block D obtained is retained in the register 111 (#4). On the other hand, the data blocks A, B, and C in the other registers 111 (#2 to #4) are shifted to the respective adjacent registers 111 (#1 to #3) via the selectors 12 selecting these registers 111 (#2 to #4), respectively. As a result, the registers 111 (#1 to #4) retain the data blocks A, B, C, and D, respectively, as its contents.

The process shown in FIGS. 11A to 11E corresponds to one stage of a round function. If a round function composed of a plurality of stages is repeated, the final result of the preceding round function may be directly input as an initial value for the following function. Then, a procedure similar to the one shown in FIGS. 11A to 11E may be executed. In this manner, the data encrypted by the encryption apparatus are decrypted to obtain the original data.

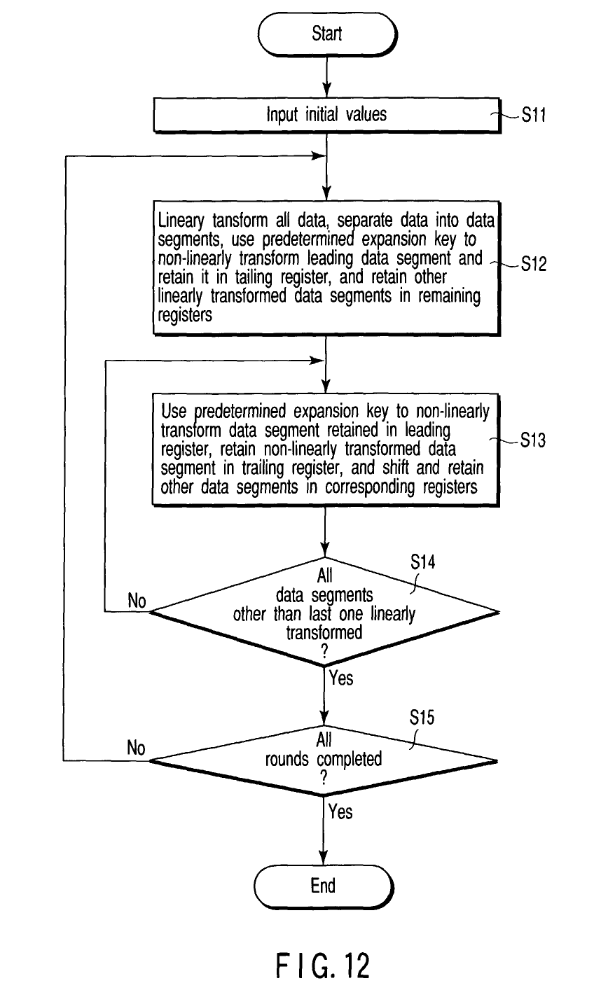

FIG. 12 shows an example of a process procedure executed if the decryption apparatus shown in FIG. 8 repeats a process using a round function composed of a plurality of stages.

When this process is started, the registers 111 receive and retain corresponding initial values (step S11). The initial values each correspond to a data block having m/n bits if m-bit data are separated into n blocks.

In response to a control signal from the control part (not shown), the selectors 12 select the linear transformer. Then, data corresponding to the set of data blocks set in all registers 111 are input to the linear transformer 13 and then linearly transformed. The linearly transformed data are separated into data blocks again. These data blocks are input to the corresponding registers 11 and retained therein (step S12). The data block corresponding to a leading portion is input to the non-linear transformer 14, where it is non-linearly transformed using an expansion key provided by a key processing part (not shown). The non-linearly transformed data block from the non-linear transformer 14 is input to the trailing register and retained therein. On the other hand, the data blocks other than the one corresponding to the leading portion are shifted toward the leading portion of the circuit and input to and retained in the corresponding registers.

Then, in response to a control signal from the control part (not shown), the selectors 112 select the corresponding registers 111. The segment data retained in the leading register 11 are input to the non-linear transformer 14. Then, the non-linear transformer 14 non-linearly transforms the segment data using the expansion key provided by the key scheduler of the key processing part (not shown). As described previously, the other data blocks are shifted to the respective adjacent registers and retained therein (step S13).

The processing in step S13 is repeated until the data blocks other than the last to be non-linearly transformed are non-linearly transformed (step S14). Thus, the results of application of one stage of the round function to the data to be processed are retained in the registers. Then, one round is completed.

Subsequently, the data blocks retained in the registers 111 upon completion of one round are used as initial values for the next round function. Then, steps S12 to S14 are executed. Steps S12 to S14 are executed for a predetermined number of rounds (step S15). Once all rounds are finished, the decryption process is completed.

The configuration of the encryption apparatus in FIG. 2 and the configuration of the decryption apparatus in FIG. 8 may change their roles with each other. That is, the configuration in FIG. 8 may be used as an encryption apparatus. The configuration in FIG. 2 may be used as a decryption apparatus corresponding to the encryption apparatus.

In the encryption apparatus shown in FIG. 2 and the decryption apparatus shown in FIG. 8, the one non-linear transformer 14 or 114 is provided for the n registers 11 or 111. However, in order to improve nonlinear transformation processing speed, the encryption apparatus and the corresponding decryption apparatus may employ a circuit configuration in which one nonlinear transformer 14-1, 14-2, 114-1, or 114-2 is provided for k (n=k×p; k and p are integers; k>1, p>1) registers 11 or 111 and which comprises n registers 11 or 111 and p non-linear transformers 14-1 and 14-2 or 114-1 and 114-2. The encryption apparatus and the corresponding decryption apparatus may be provided with p loop circuits formed of registers 11, selectors 12, and a non-linear transformer 14.

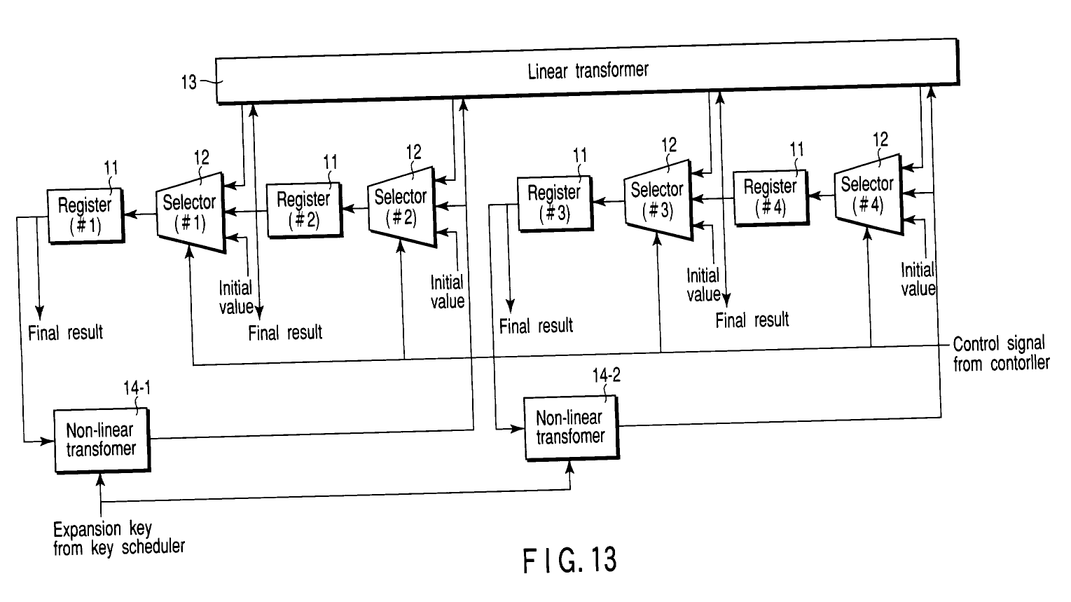

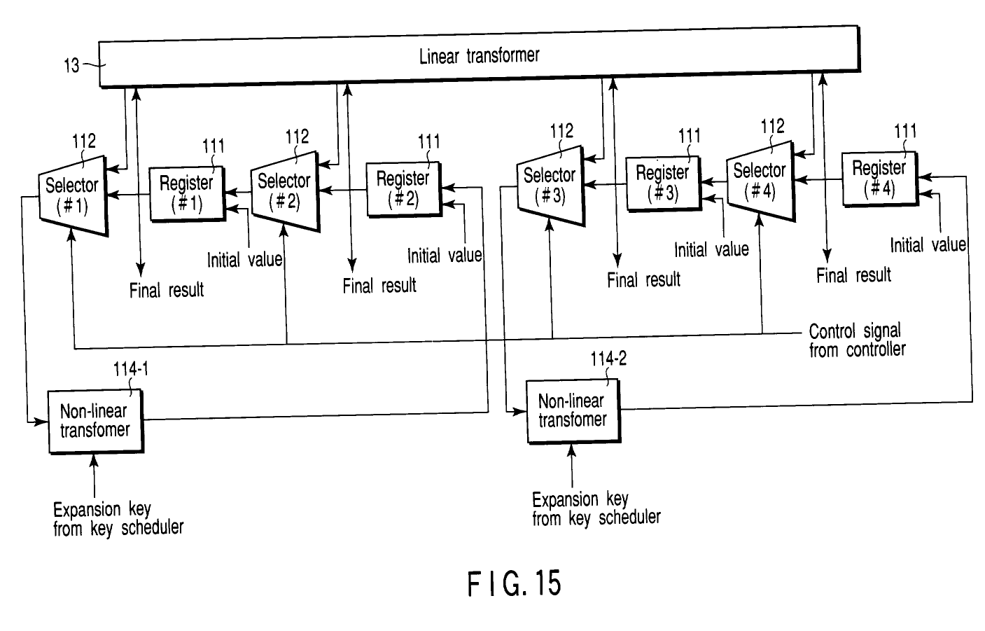

The encryption and decryption circuits shown in FIGS. 13 and 15, respectively, will be described. The encryption and decryption circuits shown in FIGS. 13 and 15, respectively, are each provided with four (n=4) registers 11 or 111 and two (p=2) non-linear transformers 14-1 and 14-2 or 114-1 and 114-2.

The encryption circuit shown in FIG. 13 is provided with two groups of data transfer paths through which data blocks are transferred wherein a loop is formed by a series arrangement including one non-linear transformer 14-1 or 14-2, registers 11, and selectors 12. In this encryption apparatus, as with the circuit shown in FIG. 2, m-bit input data are separated into n initial data blocks as described with reference to FIG. 1. The n initial data blocks are input to corresponding registers 11 as initial values. In this encryption apparatus, as with the circuit shown in FIG. 2, the n data blocks are encrypted, and the n registers 11 then output the respective final data blocks as final results. The set of n final data blocks is output as m-bit encrypted output data. The encryption apparatus comprises a linear transformer 13 to which n data blocks are provided by the registers 11. The linear transformer 13 linearly transforms m-bit data corresponding to a set of n data blocks, separates the m-bit data into n data blocks, and outputs these data blocks to the selectors 12.

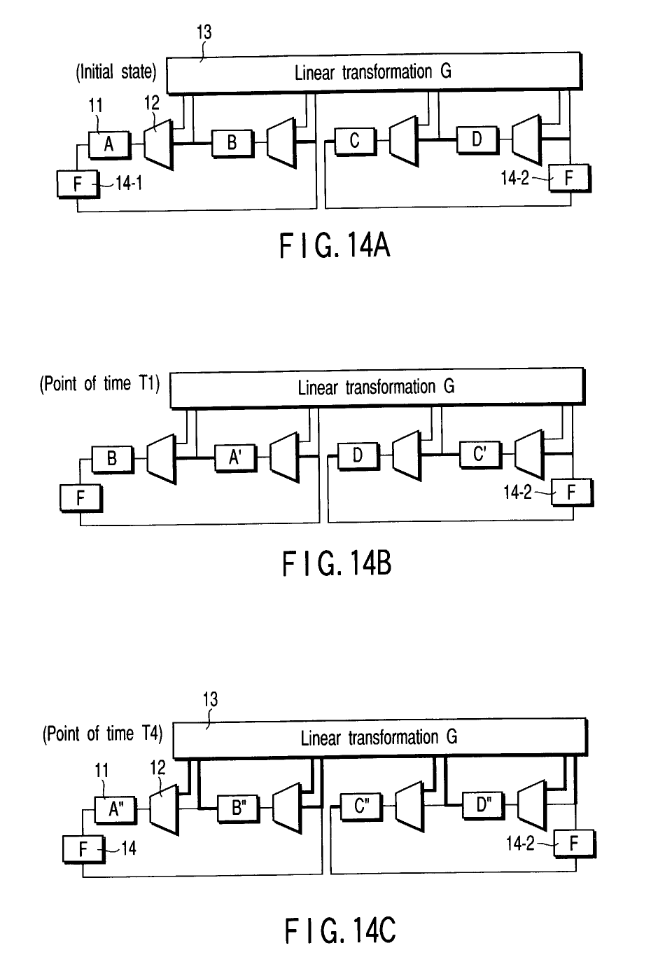

Now, data encryption carried out by the encryption apparatus shown in FIG. 13 will be described with reference to FIGS. 14A to 14C, using the symbols shown in FIG. 4. FIG. 14A shows an initial state in which segment data A, B, C, and D are input to the registers 11. FIG. 14B shows a process executed at a point of time T1 if the selectors 12 select the inputs from the corresponding registers 11 as shown in FIG. 3. FIG. 14C shows a process executed at a point of time Tn if the selectors 12 select the inputs from the linear transformer 13 as shown in FIG. 3.

In the initial state, the data blocks A, B, C, and D are input to the registers 11 (#1 to #4) and retained therein as shown in FIG. 14A.

At the point of time T1, a non-linear transformation mode is set. As shown in FIG. 14B, the data block A, set in the first register 11 (#1), is output to the non-linear transformer 14-1 in response to a control signal. In the non-linear transformer 14-2, the data block A is subjected to the non-linear transformation F and thus transformed into a data block A′. Further, the data block C, set in the third register 11 (#3), is output to the non-linear transformer 14-2 in response to a control signal. In the non-linear transformer 14-2, the data block C is subjected to the non-linear transformation F and thus transformed into a data block C′. The data block A′ is transferred to the second register 11 (#2) via the selector 12 selecting the non-linear transformer 14-1, and is retained in the second register 11 (#2). Likewise, the data block C′ is transferred to the fourth register 11 (#4) via the selector 12 selecting the non-linear transformer 14-2, and is retained in the fourth register 11 (#4). Further, at the point of time T1, the data blocks B and D, placed in the other registers 11 (#2 and #3), are shifted to the respective adjacent registers 11 (#2 and #3) via the selectors 12 selecting these registers 11 (#2 and #3), respectively. As a result, after the point of time T1, the registers 11 (#1 to #4) retain the data blocks B, A′, D, and C′, respectively, as its contents.

At the point of time Tn, the non-linear transformation mode is switched to a linear transformation mode, which is then set. In this linear transformation modes, as shown in FIG. 14C, the data block B, set in the first register 11 (#1), is similarly output to the non-linear transformer 14-1. In the non-linear transformer 14-1, the data block B is subjected to the non-linear transformation F and transformed into a data block B′. Further, the data block D, set in the third register 11 (#3), is similarly output to the non-linear transformer 14-2. In the non-linear transformer 14-2, the data block B is subjected to the non-linear transformation F and transformed into a data block D′. Furthermore, at the point of time Tn, the linear transformer 13 receives the data block A′, retained in the second register 11 (#2), the data block C′, retained in the fourth register 11 (#3), and the data blocks B′ and D, output by the linear transformers 14-1 and 14-2, respectively. In the linear transformer 13, the data blocks A′, B′, C′, and D′ are subjected to the linear transformation G and linearly transformed into the data blocks A″, B″, C″, and D″. The data blocks A″, B″, C″, and D″ are transferred to the registers 11 (#1 to #4) via the selectors 1 to 4 selecting the linear transformer 13 at the point of time Tn, and are retained in these registers.

The process shown in FIGS. 14A to 14C corresponds to one stage of a round function. If a round function composed of a plurality of stages is repeated, the final result of the preceding round function may be directly input as an initial value for the following function. Then, a procedure similar to the one shown in FIGS. 14A to 14C may be executed.

A process procedure similar to the one shown in FIG. 6, already described, if the encryption apparatus shown in FIG. 13 repeats a process using a round function composed of a plurality of stages. In the process executed by the encryption apparatus shown in FIG. 13, the leading register and last data block in the data transfer loop correspond to the leading register and last data block in the flow of FIG. 6. Accordingly, transformation of the data blocks can be fully understood on the basis of the flow shown in FIG. 6. Thus, description of the transformation will be omitted.

The decryption circuit shown in FIG. 15 is provided with two groups of data transfer paths through which data blocks are transferred wherein a loop is formed by a series arrangement including one non-linear transformer 114-1 or 114-2, registers 111, and selectors 112. m-bit input data are separated into n initial data blocks as described with reference to FIG. 7. The n initial data blocks are input to corresponding registers 111 as initial values. In this decryption apparatus, the n data blocks are decrypted, and the n registers 11 then output the respective final data blocks as final results. The set of n final data blocks is output as m-bit decrypted output data. The decryption apparatus comprises a linear transformer 113 to which n data blocks are provided by the registers 111. The linear transformer 113 linearly transforms m-bit data corresponding to a set of n data blocks, separates the m-bit data into n data blocks, and outputs these data blocks to the selectors 112.

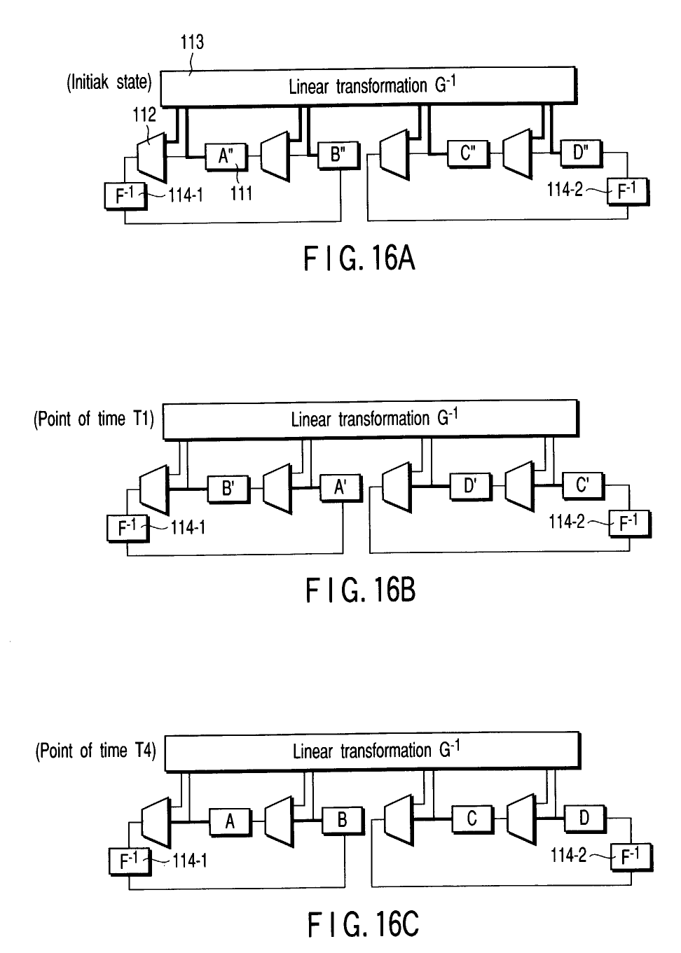

Now, data decryption carried out by the decryption apparatus shown in FIG. 15 will be described with reference to FIGS. 16A to 16C, using the symbols shown in FIG. 4. FIG. 16A shows an initial state in which segment data A, B, C, and D are input to the registers 11. FIG. 16B shows a process executed at a point of time T1 if the selectors 12 select the inputs from the linear transformer 113 as shown in FIG. 3. FIG. 14C shows a process executed at a point of time Tn if the selectors 12 select the inputs from the corresponding registers as shown in FIG. 3.

In the initial state, the linear transformation mode is set, and data blocks A″, B″, C″, and D″ are input to the registers 111 (#1 to #4) and retained therein as shown in FIG. 16A.

At the point of time T1, the linear transformation mode is similarly set. As shown in FIG. 16B, the linear transformer 113 receives the data block A″, retained in the register 111, the data block B″, retained in the register 2, the data block C″, retained in the register 3, and the data block D′, retained in the register 3. The linear transformer 113 subjects the data blocks A″, B″, C″, and D″ to the linear transformation G⁻¹ to transform them into the data blocks A′, B′, C′, and D′. The data blocks B′ and D′ obtained are transferred to the registers 111 (#1 and #3) via the selectors 112 (#2 and #4) and are retained in these registers. The data block A′ is provided to the non-linear transformer 114-1 via the selector 112 (#1) and subjected to the non-linear transformation F. The data block A obtained is retained in the register 111 (#1). The data block C′ is provided to the nonlinear transformer 114-2 via the selector 112 (#3) and subjected to the non-linear transformation F. The data block C obtained is retained in the register 111 (#1). As a result, the registers 111 (#1 to #4) retain the data blocks B′, A, D′, and C.

At the point of time Tn, the linear transformation mode is switched to a non-linear transformation mode, which is then set. In this non-linear transformation mode, as shown in FIG. 16C, the data block B′, retained in the register 111 (#1), is provided to the non-linear transformer 14 and then subjected to the non-linear transformation F. The data block B obtained is retained in the register 111 (#2). Further, the data block D′, retained in the register 111 (#3), is provided to the non-linear transformer 14 and then subjected to the non-linear transformation F. The data block D obtained is retained in the register 111 (#4). On the other hand, the data blocks A and C in the other registers 111 (#2 and #4) are shifted to the respective adjacent registers 111 (#1 and #3) via the selectors 12 selecting these registers 111 (#2 and #4), respectively. As a result, the registers 111 (#1 to #4) retain the data blocks A, B, C, and D, respectively.

The process shown in FIGS. 16A to 16C corresponds to one stage of a round function. If a round function composed of a plurality of stages is repeated, the final result of the preceding round function may be directly input as an initial value for the following function. Then, a procedure similar to the one shown in FIGS. 16A to 16C may be executed. In this manner, the data encrypted by the encryption apparatus are decrypted to obtain the original data.

A process procedure similar to the one shown in FIG. 12 if the decryption apparatus in FIG. 15 repeats a process using a round function composed of a plurality of stages. In the process executed by the decryption apparatus shown in FIG. 15, the leading register and last data block in the data transfer loop correspond to the leading register and last data block in the flow of FIG. 12. Accordingly, transformation of the data blocks can be fully understood on the basis of the flow shown in FIG. 12. Thus, description of the transformation will be omitted.

The configuration of the encryption apparatus in FIG. 13 and the configuration of the decryption apparatus in FIG. 15 may change their roles with each other. That is, the configuration in FIG. 15 may be used as an encryption apparatus. The configuration in FIG. 13 may be used as a decryption apparatus corresponding to the encryption apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An encryption apparatus for encrypting data using round function processes, comprising:
first to n-th register modules electrically arranged in series, each register module having a selector in order to select data and a register in order to store the selected data temporally and in order to output the stored data;
a first transform unit, connected to the register in the first register module, configured to transform data outputted from the register in the first register module according to an input key and output the transformed data to the selector in the n-th register module; and,
a second transform unit, connected to the registers, configured to input data from the registers respectively, merge the inputted data, transform the merged data by a predetermined linear transform method, divide the transformed data into n number, and output the divided data to the selectors of the register module, respectively.

2. The encryption apparatus according to claim 1, further comprising a key scheduler configured to supply the input key to the first transform unit.

3. The encryption apparatus according to claim 1, further comprising a controller configured to control the first to n-th register modules, respectively, the controller setting the register modules in a data input mode to receive the data and store the data in the registers, respectively, and setting the register modules in a data output mode to output the data stored in the blocks stored in the registers outside of the encryption apparatus.

4. The encryption apparatus according to claim 1, wherein the series arrangement of the register modules and the first transformed forms a loop circuit.

5. The encryption apparatus according to claim 1, further comprising a controller configured to control the first to n-th register modules, respectively, the controller setting the register modules in a non-linear transfer mode in which the data are shifted from the first register module to the first transform unit and from the second to n-th register modules to the first to (n−1)-th register modules, respectively, and the controller setting the register modules in a linear transfer mode in which the transformed data are transferred to the second transform unit from the first transform unit and from the second to n-th register modules, and the divided data are transferred to the first to n-th register modules, respectively, and the round function processes in a first round being executed by setting the non-linear mode and subsequently setting the linear transfer modes

6. The encryption apparatus according to claim 5, wherein in a round function process in a new round following the first round, the control circuit sets the non-linear transformation mode and subsequently set the linear transformation mode to execute a next new round.

7. The encryption apparatus according to claim 6, wherein the controller sets the register modules in a data output mode to output the data stored in the blocks stored in the registers outside of the encryption apparatus, after the control circuit executes a predetermined number of rounds.

8. The encryption apparatus according to claim 1, wherein the encryption apparatus is of an SPN type.

9. The encryption apparatus according to claim 1, further comprising a controller configured to control the first to n-th register modules, respectively, the controller setting the register modules in a linear transfer mode in which the data are transferred to the second transform unit from the first to n-th register modules, and the divided data are transferred to the first to n-th register modules, respectively, and the controller setting the register modules in a non-linear transfer mode in which the divided data sequentially are transferred from the first register module to the n-th register module through the first transform unit and are shifted from the second- to n-th register modules to the first to (n−1)-th register modules, respectively, and the round function processes in a first round being executed by setting the linear mode and subsequently setting the non-linear transfer modes.

10. The encryption apparatus according to claim 9, wherein in a round function process in a new round following the first round, the control circuit sets the non-linear transformation mode and subsequently set the linear transformation mode to execute a next new round.

11. The encryption apparatus according to claim 10, wherein the controller sets the register modules in a data output mode to output the data stored in the blocks stored in the registers outside of the encryption apparatus, after the control circuit executes a predetermined number of rounds.

12. A decryption apparatus for decrypting data using round function processes, comprising:
first to n-th register modules electrically arranged in series, each register module having a selector in order to select data and a register in order to store the selected data temporally and in order to output the stored data;
a first transform unit, connected to the register in the first register module, configured to transform data outputted from the register in the first register module according to an input key and output the transformed data to the selector in the n-th register module; and,
a second transform unit, connected to the registers, configured to input data from the registers respectively, merge inputted data, transform the merged data by a predetermined linear transform method, divide the transformed data into n number, and output the divided data to the selectors of the register module, respectively.

13. The decryption apparatus according to claim 12, further comprising a key scheduler configured to supply the input key to the first transform unit.

14. The decryption apparatus according to claim 12, further comprising a controller configured to control the first to n-th register modules, respectively, the controller setting the register modules in a data input mode to receive the data and store the data in the registers, respectively, and setting the register modules in a data output mode to output the data stored in the blocks stored in the registers outside of the decryption apparatus.

15. The decryption apparatus according to claim 12, wherein the series arrangement of the register modules and the first transformed forms a loop circuit.

16. The decryption apparatus according to claim 12, further comprising a controller configured to control the first to n-th register modules, respectively, the controller setting the register modules in a non-linear transfer mode in which the data are shifted from the first register module to the first transform unit and from the second to n-th register modules to the first to (n−1)-th register modules, respectively, and the controller setting the register modules in a linear transfer mode in which the transformed data are transferred to the second transform unit from the first transform unit and from the second to n-th register modules, and the divided data are transferred to the first to n-th register modules, respectively, and the round function processes in a first round being executed by setting the nonlinear mode and subsequently setting the linear transfer modes

17. The decryption apparatus according to claim 16, wherein in a round function process in a new round following the first round, the control circuit sets the non-linear transformation mode and subsequently set the linear transformation mode to execute a next new round.

18. The decryption apparatus according to claim 17, wherein the controller sets the register modules in a data output mode to output the data stored in the blocks stored in the registers outside of the decryption apparatus, after the control circuit executes a predetermined number of rounds.

19. The encryption apparatus according to claim 12, wherein the encryption apparatus is of an SPN type.

20. The encryption apparatus according to claim 12, further comprising a controller configured to control the first to n-th register modules, respectively, the controller setting the register modules in a linear transfer mode in which the data are transferred to the second transform unit from the first to n-th register modules, and the divided data are transferred to the first to n-th register modules, respectively, and the controller setting the register modules in a non-linear transfer mode in which the divided data sequentially are transferred from the first register module to the n-th register module through the first transform unit and are shifted from the second- to n-th register modules to the first to (n−1)-th register modules, respectively, and the round function processes in a first round being executed by setting the linear mode and subsequently setting the non-linear transfer modes

21. The decryption apparatus according to claim 20, wherein in a round function process in a new round following the first round, the control circuit sets the non-linear transformation mode and subsequently set the linear transformation mode to execute a next new round.

22. The encryption apparatus according to claim 21, wherein the controller sets the register modules in a data output mode to output the data stored in the blocks stored in the registers outside of the decryption apparatus, after the control circuit executes a predetermined number of rounds.

23. An encryption apparatus for encrypting data using round function processes, comprising:
loop circuits, each including;
first to n-th register modules electrically arranged in series, each register module having a selector in order to select data and a register in order to store the selected data temporally and in order to output the stored data; and
a first transform unit, connected to the register in the first register module, configured to transform data outputted from the register in the first register module according to an input key and output the transformed data to the selector in the n-th register module, and the series arrangement of the register modules and the first transformed forming one of the loop circuit; and,
a second transform unit, connected to the registers of the loop circuits, configured to input data from registers respectively, merge inputted data, transform the merged data by a predetermined linear transform method, divide the transformed data into n number, and output the divided data to the selectors of the register module, respectively.

24. The encryption apparatus according to claim 23, further comprising a key scheduler configured to supply the input key to each of the first transform units of the loop circuits.

25. The encryption apparatus according to claim 23, further comprising a controller configured to control the first to n-th register modules, respectively, the controller setting the register modules in a non-linear transfer mode in which the data are shifted from the first register module to the first transform unit and from the second to n-th register modules to the first to (n−1)-th register modules, respectively, and the controller setting the register modules in a linear transfer mode in which the transformed data are transferred to the second transform unit from the first transform unit and from the second to n-th register modules, and the divided data are transferred to the first to n-th register modules, respectively, and the round function processes in a first round being executed by setting the nonlinear mode and subsequently setting the linear transfer modes.

26. The encryption apparatus according to claim 23, further comprising a controller configured to control the first to n-th register modules of the loop circuit at the same time, respectively, the controller setting the register modules in a linear transfer mode in which the data are transferred to the second transform unit from the first to n-th register modules, and the divided data are transferred to the first to n-th register modules, respectively, and the controller setting the register modules in a non-linear transfer mode in which the divided data sequentially are transferred from the first register module to the n-th register module through the first transform unit and are shifted from the second- to n-th register modules to the first to (n−1)-th register modules, respectively, and the round function processes in a first round being executed by setting the linear mode and subsequently setting the non-linear transfer modes.

27. A decryption apparatus for decrypting data using round function processes, comprising:
circuit loops, each including;
first to n-th register modules electrically arranged in series, each register module having a selector in order to select data and a register in order to store the selected data temporally and in order to output the stored data; and
a first transform unit, connected to the register in the first register module, configured to transform data outputted from the register in the first register module according to an input key and output the transformed data to the selector in the n-th register module; and,
a second transform unit, connected to the registers of the loop circuits, configured to input data from registers respectively, merge inputted data, transform the merged data by a predetermined linear transform method, divide the transformed data into n number, and output the divided data to the selectors of the register module, respectively.

28. The decryption apparatus according to claim 27, further comprising a key scheduler configured to supply the input key to each of the first transform units of the loop circuits.

29. The decryption apparatus according to claim 27, further comprising a controller configured to control the first to n-th register modules of the loop circuits at the same time, respectively, the controller setting the register modules in a non-linear transfer mode in which the data are shifted from the first register module to the first transform unit and from the second to n-th register modules to the first to (n−1)-th register modules, respectively, and the controller setting the register modules in a linear transfer mode in which the transformed data are transferred to the second transform unit from the first transform unit and from the second to n-th register modules, and the divided data are transferred to the first to n-th register modules, respectively, and the round function processes in a first round being executed by setting the non-linear mode and subsequently setting the linear transfer modes.

30. The decryption apparatus according to claim 27, further comprising a controller configured to control the first to n-th register modules of the loop circuits at the same time, respectively, the controller setting the register modules in a linear transfer mode in which the data are transferred to the second transform unit from the first to n-th register modules, and the divided data are transferred to the first to n-th register modules, respectively, and the controller setting the register modules in a non-linear transfer mode in which the divided data sequentially are transferred from the first register module to the n-th register module through the first transform unit and are shifted from the second- to n-th register modules to the first to (n−1)-th register modules, respectively, and the round function processes in a first round being executed by setting the linear mode and subsequently setting the non-linear transfer modes.
